(19) United States
(12) Patent Application Publication
(10) Pub. No.: US 2010/0056096 A1
(43) Pub. Date: Mar. 4, 2010

(54) Method for driving a ground reference on a signal path, control circuit for driving a ground reference on a signal path, and mobile device

(75) Inventor: Hans Peter Koerner, Lund (SE)

Correspondence Address: EDWARDS ANGELL PALMER & DODGE LLP, P.O. BOX 55874, BOSTON, MA, 02205, US

(73) Assignee: Sony Ericsson Mobile Communications AB, Lund (SE)

(21) Appl. No.: 12/231,228

(22) Filed: Aug. 29, 2008

(51) Int. Cl. H04B 1/16

(52) U.S. Cl. 455/334

(57) ABSTRACT

A method for driving a ground reference to a signal path, a control circuit for driving a ground reference on a signal path, and a mobile device are described.

### BACKGROUND OF THE INVENTION

The present invention relates to a method for driving a ground reference on a signal path, a control circuit for driving a ground reference on a signal path, and a mobile device.

### BRIEF SUMMARY OF THE INVENTION

According to an embodiment of the present invention, a method for driving a ground reference on a signal path is provided. The signal path is used as a ground reference path for an audio signal and additionally as an input signal path for an antenna signal. According to the method, a signal of the signal path is sensed and then a differential signal corresponding to a difference between the sensed signal of the signal path and the ground signal is generated. The differential signal is supplied to the signal path, thus driving the ground reference of the audio signal.

Especially in the field of mobile devices, for example a mobile phone or a personal digital assistant (PDA), a connection between the mobile device and an external antenna or an external microphone or an external head set is provided by a so-called multiport connector. To reduce the number of ports of a multiport connector for achieving a small and cost-effective design of the multiport connector, a multiport connector may comprise for example four ports, two ports for outputting two audio signals to two loudspeakers of a stereo headset, one port for inputting an audio signal of a microphone and one port providing a signal return path, i.e. a signal ground, for the two output signals and the input signal and additionally providing a signal path for an antenna signal from an antenna provided in a wire to a microphone or the stereo head set. Due to the antenna signal, the latter port for the signal return path cannot be connected directly to ground as it would be desirable to provide a return path for the audio signals. However, by supplying the differential signal generated according to the above-described method of the present invention, the signal as a ground reference for the audio signals is provided on the signal path. Thus, a high quality audio signal can be provided, and, in case of the above-described configuration comprising a stereo headset, a microphone and an antenna, a crosstalk between the audio output signals to the loudspeakers of the stereo headset and a crosstalk between any of the output signals and the input signal of the microphone can be reduced or even completely cancelled without influencing the antenna signal.

According to an embodiment, the step of supplying the differential signal to the signal path comprises a low-pass filtering of the differential signal. The low-pass filtering may be accomplished by supplying the differential signal to the signal path via a series connection of a resistor and an inductivity. The low-pass filtering may further comprise a supplying of the differential signal to ground via a resistor and a capacity. Thus, the high frequency signals of the antenna signal comprised in the differential signal may be blocked by the inductivity and may be short cut to ground via the capacitor. Therefore, the differential signal supplied to the signal path provides a ground reference for the audio signal only without disturbing the antenna signal.

According to an embodiment, the step of generating the differential signal comprises a subtracting of the sensed signal from the ground signal with an operational amplifier. The operational amplifier is connected with its positive input to ground and with its negative input to the sensed signal. The sensed signal may be derived from the signal of the signal path via a high ohmic series resistor and/or inductor connecting the signal path with the negative input of the operational amplifier. By using the operational amplifier and the high ohmic series resistor for generating the differential signal, the signal of the signal path can be sensed without affecting the signal of the signal path due to the high impedance of the input of the operational amplifier. Furthermore, the operational amplifier provides a low-pass filtering of the signal of the signal path due to the frequency dependent transfer function of the operational amplifier. This behaviour can be further enhanced by a feedback capacitor between the negative input of the amplifier and an output of the operational amplifier.

According to an embodiment, the method further comprises a high-pass filtering of the signal of the signal path for providing the antenna signal. The antenna signal may be provided to a radio receiver. The high-pass filtering may be accomplished by connecting the signal path to the radio receiver via a capacitor. As the high-pass filtering, e.g. the capacitor, blocks the differential signal supplied to the signal path, the radio receiver can receive the antenna signal without any disturbance of the differential signal driving the ground reference.

According to an embodiment of the present invention, a control unit for driving a ground reference on a signal path is provided. The signal path is used as a ground reference path for an audio signal and as an input signal path for an antenna signal. The control circuit comprises a signal terminal for receiving a signal of a signal path and a ground terminal for receiving a ground signal. The control circuit is configured to sense the signal of the signal path, to generate a differential signal corresponding to a difference between the sensed signal of the signal path and the ground signal, and to supply the differential signal to the signal path. Thus a ground reference for the audio signal is provided by the differential signal on the signal path.

The audio signal may comprise an audio input signal from a microphone and/or an audio output signal to a loudspeaker. According to an embodiment, the audio signal comprises three audio signals, namely one audio input signal from a microphone and two audio output signals to two loudspeakers of a stereo headset.

The control circuit described above provides a ground reference on the signal path for the audio signals without disturbing the antenna signal on the signal path. Therefore, a crosstalk between the audio signals can be reliably reduced or even cancelled.

According to an embodiment, the control circuit comprises a resistor and an inductivity connecting the differential signal to the signal path. Furthermore, the control circuit may comprise a capacitor connecting the differential signal via the resistor and the capacitor to ground. The resistor and the inductivity block the high frequency signals of the differential signal and the capacitor short cuts the high frequency signals of the differential signal to ground. Therefore, a reliable filtering of the high frequency signals is achieved and thus the differential signal supplied to the signal path provides a ground reference for the audio signal without disturbing the high frequency antenna signal.

According to an embodiment, the control circuit comprises an operational amplifier for generating the differential signal. The operational amplifier is connected with a positive input of the operational amplifier to the ground signal and with a negative input of the operational amplifier to the sensed signal of the signal path. The sensing of the signal of the signal path may be achieved by connecting the signal path to the negative input of the operational amplifier via a resistor and/or inductor. Due to the high input impedance of the operational amplifier and the resistor, the signal of the signal path is not disturbed when sensing this signal. Therefore, the antenna signal comprised in the signal of the signal path is not affected by the control circuit.

According to an embodiment, the control circuit comprises furthermore a radio frequency output terminal for outputting the antenna signal and a capacitor connecting the signal path and the radio frequency output terminal. The capacitor acts as a high-pass filter and provides the antenna signal of the signal path at the radio frequency output terminal. Furthermore, the capacitor blocks the ground reference of the signal path from being output at the radio frequency output terminal. Therefore, the control circuit is adapted to output the antenna signal separated from the ground reference of the signal path.

According to another embodiment of the present invention, a mobile device is provided. The mobile device comprises a connector for connecting an audio device and a radio frequency antenna to the mobile device. The connector comprises an audio port connected to an audio signal of the mobile device and a common port connected to a signal path used in common as a ground reference path for the audio signal and as an input signal path for an antenna signal of the radio frequency antenna. The mobile device furthermore comprises a control circuit for driving a ground reference on the signal path. The control circuit comprises a signal terminal connected to the common port for receiving a signal of the signal path, and a ground terminal for receiving a ground signal. The control circuit is configured to sense the signal of the signal path, to generate a differential signal corresponding to a difference between the sensed signal of the signal path and the ground signal, and to supply the differential signal to the signal path. The differential signal is thus driving the ground reference for the audio signal.

The audio signal may comprise an audio input signal from a microphone or an audio output signal to a loudspeaker. The connector of the mobile device may comprise three separate audio ports, namely a first audio port connected to a first audio output signal, a second audio port connected to a second audio output signal, and a third audio port connected to an audio input signal for connecting a microphone to the mobile device. The first audio output signal and the second audio output signal may be adapted to provide audio signals to two separate loudspeakers of a stereo headset connected to the first audio port, the second audio port and the common port. The audio input signal may be an audio input signal of a microphone connected to the mobile device via the third audio port and the common port.

In the mobile device described above, the control circuit drives a ground reference on the signal path such that the antenna signal of the signal path is not influenced and a ground reference for the audio signals of the loudspeakers and the microphone is provided such that a crosstalk between the audio output signals and between any of the audio output signals and the audio input signal is reduced or even cancelled. Thus, a connection of an antenna, a microphone and a stereo headset can be achieved by using a very small and cost-effective multiport connector comprising only four ports, namely the three audio ports and the common port.

According to an embodiment, the control circuit of the mobile device comprises a resistor and an inductivity connecting the differential signal to the signal path. The control circuit can comprise also a capacitor connecting the differntial signal via the resistor and the capacitor to ground. In this manner, a blocking of high frequency signals comprised in the differential signal, e.g. from the antenna signal, are blocked from being supplied to the signal path by the inductivity and short cut to ground by the capacitor. Thus, the differential signal supplied to the signal path does not influence or disturb the antenna signal of the signal path.

According to an embodiment, the control circuit of the mobile device comprises an operational amplifier for generating the differential signal. The operational amplifier is connected with its positive input to the ground signal and with its negative input to the signal sensed at the signal path. Sensing the signal of the signal path may be accomplished by connecting the signal path to the negative input of the operational amplifier via a resistor and/or inductor. By use of the operational amplifier and the resistor, e.g. a high ohmic resistor of 10 KΩ, a disturbance of the signal path due to the sensing of the signal of the signal path is avoided, as the input impedance of the operational amplifier is very high. Therefore, the antenna signal of the signal path is not influenced.

According to an embodiment, a control circuit of the mobile device comprises a radio frequency output terminal for outputting the antenna signal. Furthermore, the control circuit comprises a capacitor connecting the signal terminal and the radio frequency output terminal. The capacitor is acting as a high-pass filter passing the antenna signal from the signal path to the radio frequency output terminal and blocking at the same time the ground reference on the signal path. The mobile device may further comprise a radio frequency receiver connected to the radio frequency output terminal. The radio frequency receiver may be adapted to receive a frequency modulated (FM) radio frequency signal in the very high frequency (VHF) transmission band. In this embodiment the control circuit provides the radio frequency receiver with the antenna signal from the signal path and provides at the same time a ground reference on the signal path for the audio signals for the microphone and the loudspeakers of the stereo headset.

According to an embodiment, the mobile device may be a mobile phone, a personal digitial assistant (PDA) and/or a mobile computer.

### BRIEF DESCRIPTION OF THE DRAWINGS

Hereinafter, exemplary embodiments of the invention will be described with reference to the drawings.

FIG. 1 shows a schematic view of a part of a mobile device according to an embodiment of the invention.

FIG. 2 shows a schematic view of a part of a mobile device according to another embodiment of the invention.

### DETAILED DESCRIPTION OF THE INVENTION

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and is not intended to be limited by the exemplary embodiments hereinafter.

It is also to be understood that in the following detailed description of the exemplary embodiments, any direct connection or coupling between functional blocks, devices, components or other physical or functional units shown in the drawings or description herein could also be implemented by an indirect connection or coupling.

It is further to be understood that the features of the various exemplary embodiments described herein may be combined with each other, unless specifically noted otherwise.

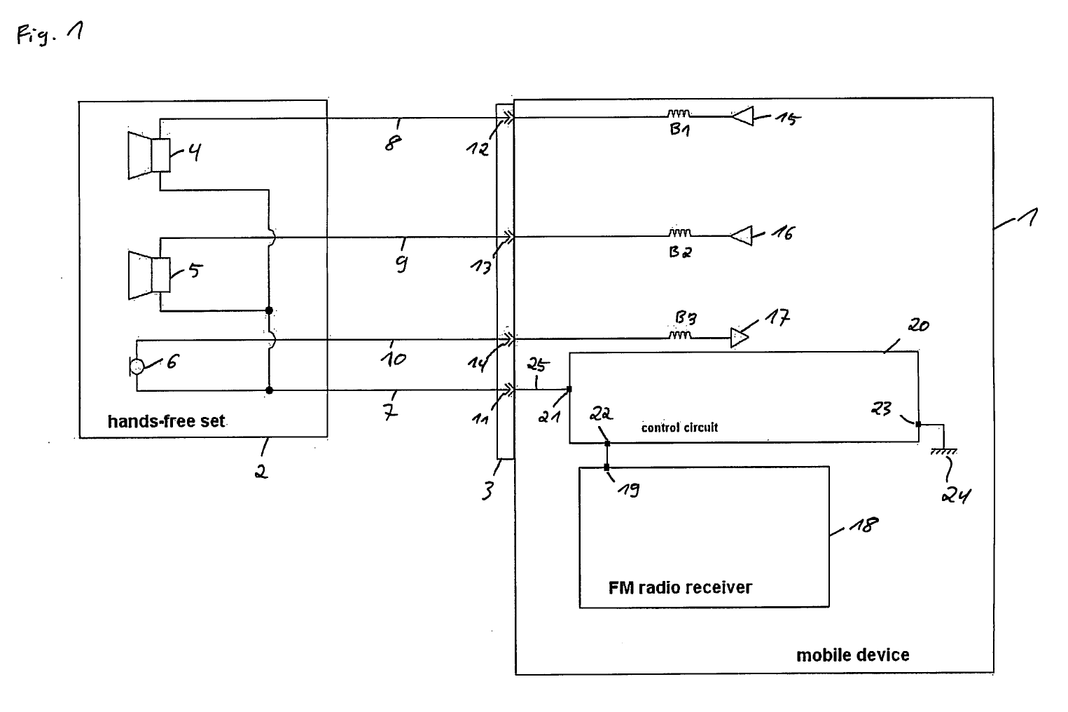

FIG. 1 shows an embodiment of mobile device 1 connected to a portable hands-free set 2 via a multiport connector 3. The portable hands-free set 2 comprises two earspeakers or loudspeakers 4, 5 for reproducing a stereo audio signal to a user of the portable hands-free set 2, a microphone 6 for receiving audio signals, for example speech, and a wiring 7-10 connecting the loudspeakers 4, 5 and the microphone 6 to the multiport connector 3.

The multiport connector 3 comprises for example four ports 11-14 for providing electrical connections from the portable hands-free set 2 to mobile device 1. As illustrated in FIG. 1, port 12 is connected to a first terminal of loudspeaker speaker 4 via the wire 8, port 13 is connected to a first terminal of the loudspeaker 5 via the wire 9, and port 14 is connected to a first terminal of the microphone 6 via the wire 10. A second terminal of the loudspeaker 4, a second terminal of the loudspeaker 5, and a second terminal of the microphone 6 are connected together to the common port 11 via the wire 7. Wire 7 additionally serves as an antenna for receiving for example a frequency modulated (FM) broadcast radio signal in for example a very high frequency (VHF) band.

The mobile device 1 comprises two earspeaker amplifiers 15, 16 adapted to drive the earspeakers or loudspeakers 4, 5 via beads B1, B2 as shown in FIG. 1. The mobile device 1 comprises furthermore a microphone amplifier 17 adapted to receive and amplify a signal from the microphone 6 received via a bead B3. The beads B1-B3 may be ferrite beads and may be used for isolating the FM antenna and to protect the amplifiers 15-17 from a current clamp. The current clamp is a test signal applied to the ports 11-14 of the multiport connector 3 during a type approval test of the mobile device. The current clamp signal introduces an amplitude modulated (AM) disturbance signal on the ports 11-14. The beads provide a very high resistance at high frequencies, for example 1.8 KΩ at 100 MHz, and a low resistance at low frequencies, for example 100Ω at 10 MHz and 1Ω at 100 KHz, thus protecting the mobile device 1 from high frequency current clamp signals.

The mobile device 1 furthermore comprises an FM radio receiver 18 having an antenna input 19. Furthermore, the mobile device 1 comprises a control circuit 20 having a signal terminal 21 for receiving a signal of signal path 25 connected to port 11 of the multiport connector, and a ground terminal 23 for receiving a ground signal 24 of the mobile device 1. Furthermore, the control circuit has a radio frequency output terminal 22 connected to the antenna input 19 of the FM radio receiver 18.

As described above, the signal path 25 is used as a ground reference path for the audio signals of the loudspeakers 4, 5 and the microphone 6 and used as an input signal path for an antenna signal. Therefore, control circuit 20 senses the signal of the signal path 25 received via the signal terminal 21 and drives a ground reference on the signal path 25 for the audio signals of the loudspeakers 4, 5 and the microphone 6, and additionally separates the antenna signal from the signal path 25 and provides the separated antenna signal at the radio frequency output terminal 22 to the FM radio receiver 18.

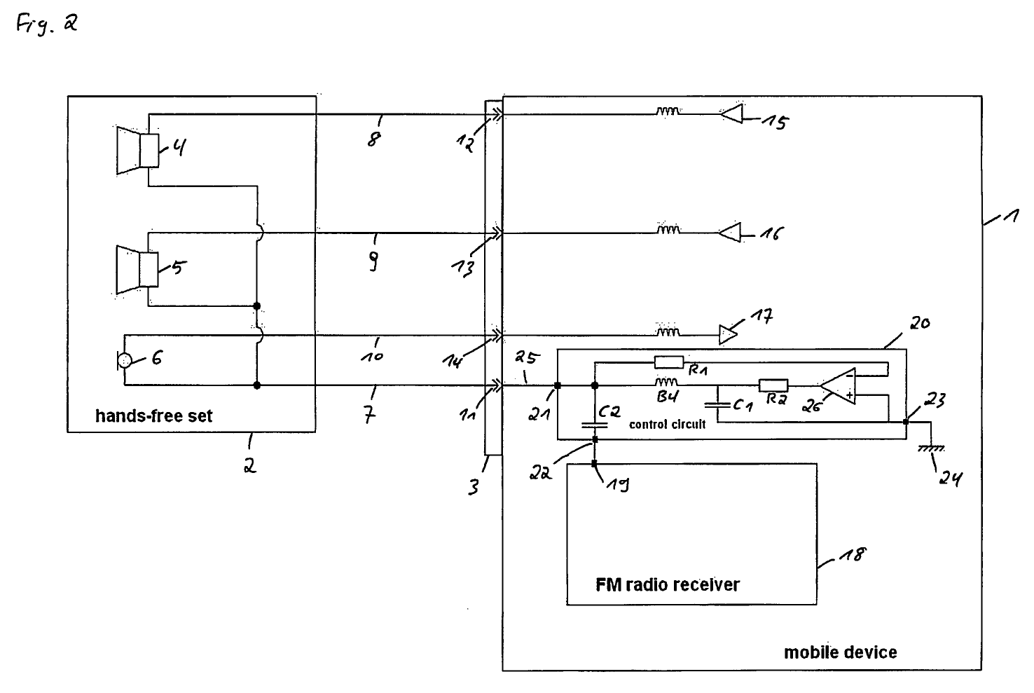

In connection with FIG. 2 the functioning of the control circuit 20 will be described in the following in more detail.

Control circuit 20 comprises a resistor R1 connecting the signal path 25 with a negative input of an operational amplifier 26. A positive input of the operational amplifier 26 is connected to the ground signal 24 of the mobile device 1. An output of the operational amplifier 26 is connected to a first terminal of another resistor R2 and a second terminal of resistor R2 is connected via a capacitor C1 to the ground signal 24 and additionally connected via an inductivity B4 to signal path 25. Finally, the control circuit 20 comprises a second capacitor C2 connecting the signal path 25 with the radio frequency output terminal 22.

The operational amplifier 26 compares the signal of signal path 25 with ground signal 24 and derives a differential signal at the output of the operational amplifier 26. As the operational amplifier 26 has a frequency dependent transfer function, the differential signal at the output of operational amplifier 26 comprises substantially a differential signal corresponding to a difference between the audio signals of the loudspeakers 4, 5 and the microphone 6 and the ground signal 24. However, the differential signal at the output of operational amplifier 26 may also comprise a small signal corresponding to the difference between the antenna signal and the ground signal 24. Therefore, resistor R2, capacitor C1 and inductivity B4 provide a filter that shortcuts those high frequency parts of the differential signal to ground and additionally pass only those parts of the differential signal to the signal path 25 that are needed for driving a ground reference for the audio signals. Consequently, the control circuit 20 provides at the signal terminal 21 a ground reference for the audio signals of the loudspeakers 4, 5 and the microphone 6 without affecting the antenna signal of the signal path 25. The ground reference provided at signal terminal 21 avoids any crosstalk between the audio signals of the loudspeakers 4, 5 and the microphone 6.

Furthermore, the control circuit 20 provides a high-pass filtering function with capacitor C2. Capacitor C2 blocks the differential signal provided from the operational amplifier 26 from the radio frequency output terminal 22 and passes the antenna signal from the signal path 25 to the radio frequency output terminal 22. Therefore, at radio frequency output terminal 22, the antenna signal without any disturbances from the audio signals or the differential signal of the operational amplifier 26 is provided.

The value of the capacitors C1 and C2 may be 1 nF each, the value of the inductivity B4 may be 270 nH, the value of resistor R1 may be 10 kΩ and the value of resistor R2 may be 100Ω. Thus, the control circuit 20 rejects any echo voltage from the loudspeaker return currents on the signal path 25 superimposed on the microphone input voltage and increases a general separation of the audio signal for the loudspeakers 4, 5 to at least 40 dB without affecting the antenna signal.

What is claimed is:

1. A method for driving a ground reference on a signal path, the signal path serving as a ground reference path for an audio signal and as an input signal path for an antenna signal, the method comprising the steps:
sensing a signal of the signal path,
generating a differential signal corresponding to a difference between the sensed signal of the signal path and a ground signal, and
supplying the differential signal to the signal path for driving the ground reference of the audio signal.

2. The method according to claim 1, wherein the step of supplying the differential signal to the signal path comprises a low-pass filtering of the differential signal.

3. The method according to claim 2, wherein the low pass filtering comprises a supplying of the differential signal to the signal path via a resistor and an inductivity.

4. The method according to claim 2, wherein the low pass filtering comprises a supplying of the differential signal to ground via a resistor and a capacity.

5. The method according to claim 1, wherein the step of generating the differential signal comprises subtracting the sensed signal from the ground signal with an operational amplifier connected with a positive input to ground and connected with a negative input to the sensed signal.

6. The method according to claim 5, wherein the step of sensing the signal of the signal path comprises a connecting of the signal path via a resistor and/or inductor to the negative input of the operational amplifier.

7. The method according to claim 1, further comprising high pass filtering of the sensed signal for providing the antenna signal.

8. The method according to claim 1, wherein the audio signal comprises an audio input signal from a microphone.

9. The method according to claim 1, wherein the audio signal comprises an audio output signal to a loudspeaker.

10. The method according to claim 1, wherein the audio signal comprises three audio signals:
an audio input signal from a microphone, and
two audio output signals to two loudspeakers of a stereo headset.

11. A control circuit for driving a ground reference on a signal path, the signal path being used as a ground reference path for an audio signal and as an input signal path for an antenna signal, the control circuit comprising:
a signal terminal for receiving a signal of the signal path, and
a ground terminal for receiving a ground signal, wherein the control circuit is configured to sense the signal of the signal path, to generate a differential signal corresponding to a difference between the sensed signal of the signal path and the ground signal, and to supply the differential signal to the signal path for driving the ground reference of the audio signal.

12. The control circuit according to claim 11, wherein the control circuit comprises a resistor and an inductivity supplying the differential signal to the signal path.

13. The control circuit according to claim 12, wherein the control circuit comprises a capacitor supplying the differential signal via the resistor and the capacitor to ground.

14. The control circuit according to claim 11, wherein the control circuit comprises an operational amplifier for generating the differential signal, the operational amplifier being connected with a positive input to the ground signal and with a negative input to the sensed signal.

15. The control circuit according to claim 14, wherein the control circuit comprises a resistor for sensing the signal of the signal path, the resistor connecting the signal path to the negative input of the operational amplifier.

16. The control circuit according to claim 11, further comprising a radio frequency output terminal for outputting the antenna signal and a capacitor connecting the signal terminal and the radio frequency output terminal for providing the antenna signal of the signal path at the radio frequency output terminal.

17. The control circuit according to claim 11, wherein the audio signal comprises an audio input signal from a microphone.

18. The control circuit according to claim 11, wherein the audio signal comprises an audio output signal to a loudspeaker.

19. The control circuit according to claim 11, wherein the audio signal comprises three audio signals:
an audio input signal from a microphone, and
two audio output signals to two loudspeakers of a stereo headset.

20. A mobile device, comprising:
a connector for connecting an audio device and a radio frequency antenna to the mobile device, the connector comprising an audio port to receive an audio signal of the mobile device and a common port connected to a signal path used in common as a ground reference path for the audio signal and as an input signal path for an antenna signal of the radio frequency antenna, and
a control circuit for driving a ground reference for the audio signal on the signal path,
wherein the control circuit comprises:
a signal terminal connected to the common port for receiving a signal of the signal path, and
a ground terminal for receiving a ground signal,
wherein the control circuit is configured to sense the signal of the signal path, to generate a differential signal corresponding to a difference between the sensed signal and the ground signal, and to supply the differential signal to the signal path.

21. The mobile device according to claim 20, wherein the control circuit comprises a resistor and an inductivity supplying the differential signal to the signal path.

22. The mobile device according to claim 21, wherein the control circuit comprises a capacitor supplying the differential signal via the resistor and the capacitor to ground.

23. The mobile device according to claim 20, wherein the control circuit comprises an operational amplifier for generating the differential signal, the operational amplifier being connected with a positive input to the ground terminal and with a negative input to the sensed signal.

24. The mobile device according to claim 23, wherein the control circuit comprises a resistor for sensing the signal of the signal path, the resistor supplying the signal path to the negative input of the operational amplifier.

25. The mobile device according to claim 20, wherein the control circuit comprises a radio frequency output terminal for outputting the antenna signal and a capacitor connecting the signal terminal and the radio frequency output terminal for providing the antenna signal of the signal path at the radio frequency output terminal.

26. The mobile device according to claim 25, wherein the mobile device further comprises a radio frequency receiver connected to the radio frequency output terminal.

27. The mobile device according to claim 26, wherein the radio frequency receiver is adapted to receive a frequency modulated radio frequency signal in the VHF transmission band.

28. The mobile device according to claim 20, wherein the audio signal comprises an audio input signal from a microphone.

29. The mobile device according to claim 20, wherein the audio signal comprises an audio output signal to a loudspeaker.

30. The mobile device according to claim 20, wherein the audio port comprises a first audio port to receive a first audio output signal for connecting a first loudspeaker to the mobile device, a second audio port to receive a second audio output signal for connecting a second loudspeaker to the mobile device, and a third audio port to receive an audio input signal for connecting a microphone to the mobile device.

31. The mobile device according to claim 20, wherein the mobile device is a device selected from the group comprising a mobile phone, a personal digital assistant, and a mobile computer.
